(19) United States
(12) Patent Application Publication
(10) Pub. No.: US 2025/0088468 A1
(43) Pub. Date: Mar. 13, 2025

(54) ADAPTATION LAYER FOR EXTENDING THE INTERNET PROTOCOL (IP) OVER HETEROGENEOUS INTERNETWORKS

(71) Applicant: The Boeing Company, Arlington, VA (US)

(72) Inventor: Fred L. TEMPLIN, North Bend, WA (US)

(21) Appl. No.: 18/960,491

(22) Filed: Nov. 26, 2024

Related U.S. Application Data
(63) Continuation-in-part of application No. 17/591,568, filed on Feb. 2, 2022, now abandoned.

(51) Int. Cl. H04L 47/36; H04L 12/46; H04L 45/74

(52) U.S. Cl. CPC H04L 47/365; H04L 12/4633; H04L 45/74

(57) ABSTRACT

A system may receive an original internet protocol (IP) packet with a size that exceeds a maximum payload size (MPS); encapsulate the original IP packet in an adaptation layer header to form an adaptation layer packet; generate a plurality of fragment payloads that do not exceed the MPS; generate a plurality of carrier packets with respective adaptation layer headers, respective fragment payloads, and an indication of a relative fragment offset of the respective fragment payload; and provide the plurality of carrier packets for transmission to a node. A destination node may receive the plurality of carrier packets, reassemble the adaptation layer packet from the plurality of fragment payloads based on the relative fragment offset for each respective fragment payload; and remove the adaptation layer header from the adaptation layer packet to obtain the original IP packet.

### RELATED APPLICATION

This application is a continuation in part of U.S. patent application Ser. No. 17/591,568, filed Feb. 2, 2022, which is incorporated herein by reference in its entirety.

### BACKGROUND

Internetworks are common and arise when different computer networks are connected, such as by connecting a local area network (LAN) with a wide area network (WAN), connecting two or more LANs, or connecting two or more WANs. When multiple internetworks are joined together, their protocols or parameters may differ and the concatenated internetworks become heterogeneous.

Computer networks commonly use internet protocol (IP) packets for communication, which each include a header with addressing (and other) information and a payload that contains the actual data to be communicated (e.g., transmitted across a network). A network will have a maximum transmission unit (MTU), and a packet exceeding the network's MTU will not move across the network. Therefore, large blocks of data to be transmitted, that exceed a network's MTU, may be fragmented into multiple payloads and transmitted using multiple packets. Larger MTUs permit the use of fewer packets, whereas smaller MTUs drive up the number of required packets. Because the packet header is overhead, the fewer packets required to transmit a fixed amount of data, the greater the efficiency of a network.

However, the different concatenated network segments of a heterogeneous internetwork may have different MTUs, and which may even change over time. Using packets that are too large for some networks (in some conditions) results in dropped packets, slowing throughput and introducing inefficiency. A blind approach of using only a fixed packet size (e.g., 576 bytes), that is limited to the smallest MTU that could be encountered at any time on any one of the different networks, is inefficient in scenarios in which at least some of the networks may accept a larger MTU.

### SUMMARY

The disclosed examples are described in further detail below with reference to the accompanying drawing figures listed below. The following summary is provided to illustrate examples or implementations disclosed herein. It is not meant, however, to limit all examples to any particular configuration or sequence of operations.

In some embodiments, a network communication path has a plurality of nodes including a source node and a destination node, and each node of the plurality of nodes has an adaptation layer interface. A method may include receiving an original internet protocol (IP) packet into the adaptation layer interface of the source node, wherein the original IP packet comprises an original header and an original payload, and wherein a size of the original IP packet exceeds a maximum payload size (MPS); performing, by the adaptation layer interface of the source node, operations comprising: encapsulating the original IP packet in an adaptation layer header to form an adaptation layer packet; based on at least the MPS and the size of the original IP packet, fragmenting the adaptation layer packet into a plurality of fragment payloads, wherein each fragment payload of the plurality of fragment payloads does not exceed the MPS; and generating a plurality of carrier packets, wherein each carrier packet comprises a respective adaptation layer header and a respective fragment payload of the plurality of fragment payloads, and wherein for each carrier packet the respective adaptation layer header includes an indicator of a relative fragment offset associated with the respective fragment payload; providing the plurality of carrier packets for transmission to a first node of the plurality of nodes; and when the plurality of carrier packets are received at the destination node, performing, by the adaptation layer interface of the destination node, operations comprising: reassembling the adaptation layer packet from the plurality of fragment payloads based on the relative fragment offset associated with each respective fragment payload; and removing the adaptation layer header from the adaptation layer packet to obtain the original IP packet.

In some embodiments, a computer program product may comprise a non-transitory computer usable medium having a computer readable program code embodied therein, wherein the computer readable program code is adapted to be executed to implement the above method in a network communication path having a plurality of nodes including a source node and a destination node, wherein each node of the plurality of nodes has an adaptation layer interface.

In some embodiments, a system comprises a plurality of nodes including a source node and a destination node, wherein each node of the plurality of nodes has an adaptation layer interface. The plurality of nodes may include one or more processors (e.g., a first processor, a second processor, a third processor, and so on) and one or more memories (e.g., a first memory, a second memory, a third memory, and so on) storing instructions (e.g., first instructions, second instructions, third instructions, and so on) that, when executed by the one or more processors, causes the one or more processors to perform the above method.

### BRIEF DESCRIPTION OF THE DRAWINGS

The disclosed examples are described in detail below with reference to the accompanying drawing figures listed below:

FIG. 1 illustrates an arrangement 100 that advantageously provides an adaptation layer for the internet protocol (IP) over heterogeneous internetworks, in accordance with an example.

FIG. 2 shows a representative seven-layer network model 200.

FIG. 3A illustrates an adaptation layer model 300 as may be used in the arrangement 100 of FIG. 1, in accordance with an example.

FIG. 3B maps elements of the adaptation layer model 300 of FIG. 3A to elements of the seven-layer network model 200 of FIG. 2.

FIG. 4 illustrates details of network layering for the adaptation layer model 300 of FIG. 3A, as may occur in the arrangement 100 of FIG. 1, in accordance with an example.

FIG. 5 illustrates fragmenting and encapsulating an original IP packet 504, as may occur in the arrangement 100 of FIG. 1, in accordance with an example.

FIG. 6 illustrates an adaptation layer header 502, as may be used in a carrier packet 531 of FIG. 5, in accordance with an example.

FIG. 7 is a flowchart 700 illustrating a method of adapting IP for heterogeneous internetworks, as may be used with the arrangement 100 of FIG. 1, in accordance with an example.

FIG. 8 is a flowchart 800 illustrating another method of adapting IP for heterogeneous internetworks, as may be used with the arrangement 100 of FIG. 1, in accordance with an example.

FIG. 9 is a block diagram of a computing device 1200 suitable for implementing various aspects of the disclosure in accordance with an example.

FIG. 10 is a block diagram of an apparatus production and service method 1000 that employs various aspects of the disclosure in accordance with an example.

FIG. 11 is a block diagram of an apparatus 1100 for which various aspects of the disclosure may be advantageously employed in accordance with an example.

FIG. 12 is a schematic perspective view of a particular flying apparatus 1101 in accordance with an example.

FIG. 13 is a flowchart illustrating a method of adapting IP for heterogeneous internetworks in accordance with an example.

FIG. 14 is a flowchart illustrating a method of adapting IP for heterogeneous internetworks in accordance with an example.

Corresponding reference characters indicate corresponding parts throughout the drawings in accordance with an example.

### DETAILED DESCRIPTION

The various examples will be described in detail with reference to the accompanying drawings. Wherever possible, the same reference numbers will be used throughout the drawings to refer to the same or like parts. References made throughout this disclosure relating to specific examples and implementations are provided solely for illustrative purposes but, unless indicated to the contrary, are not meant to limit all implementations.

The foregoing summary, as well as the following detailed description of certain implementations will be better understood when read in conjunction with the appended drawings. As used herein, an element or step recited in the singular and preceded by the word “a” or “an” should be understood as not necessarily excluding the plural of the elements or steps. Further, references to an implementation or an example are not intended to be interpreted as excluding the existence of additional examples that also incorporate the recited features. Moreover, unless explicitly stated to the contrary, examples “comprising” or “having” an element or a plurality of elements having a particular property could include additional elements not having that property.

Aspects and implementations disclosed herein are directed to adapting internet protocol (IP) for heterogeneous internetworks. An original IP packet is received into a source interface. The original IP packet comprises an original header and an original payload, and a size of the original IP packet exceeds a maximum payload size (MPS). Based on at least the MPS and the size of the original IP packet, the original IP packet is fragmented (for later reassembly by a destination interface) into a plurality of fragment payloads, each of which does not exceed the MPS. A plurality of carrier packets is generated that each comprise an encapsulation header and one fragment payload, and which are transmitted over a downstream network to a destination interface. The source and destination interfaces may be overlay multilink network interfaces (OMNI) that embody the OMNI adaptation layer (OAL). Example source interfaces use probing to determine a largest MPS supported by the downstream network. This reduces the number of fragments and improves network efficiency.

Aspects of the disclosure have a technical effect of improved reliability of computer networks, for example by reducing the number of dropped packets when transmitting data over heterogeneous internetworks, which may each have a different MPS. This is accomplished by, based on at least an MPS and a size of the original IP packet, fragmenting the original IP packet into a plurality of fragment payloads, wherein each fragment payload of the plurality of fragment payloads does not exceed the MPS. Aspects of the disclosure have a further technical effect of improved efficiency of computer networks, for example by reducing the number of different packets that are required to transmit a fixed amount of data over heterogeneous internetworks, which may each have different MPS. This is accomplished by probing to determine a largest MPS supported by a downstream network.

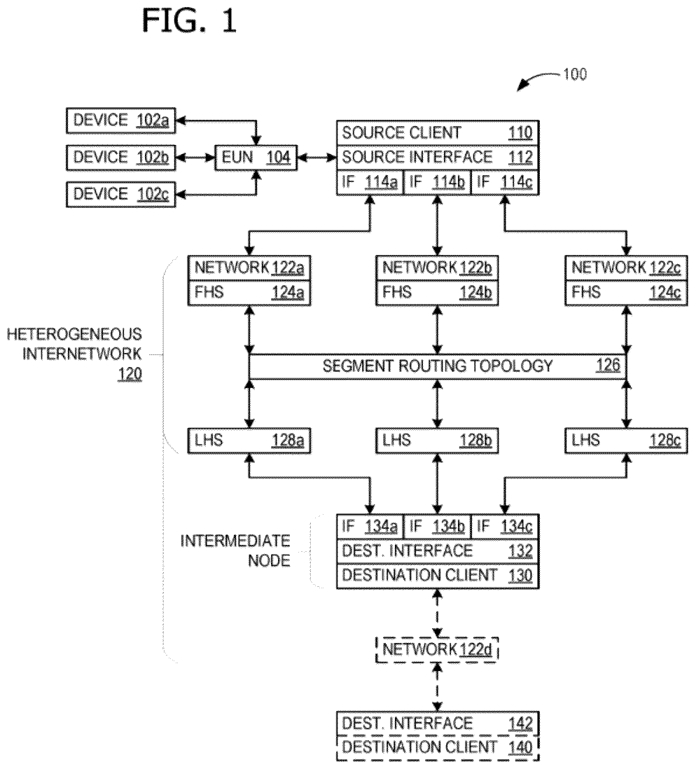

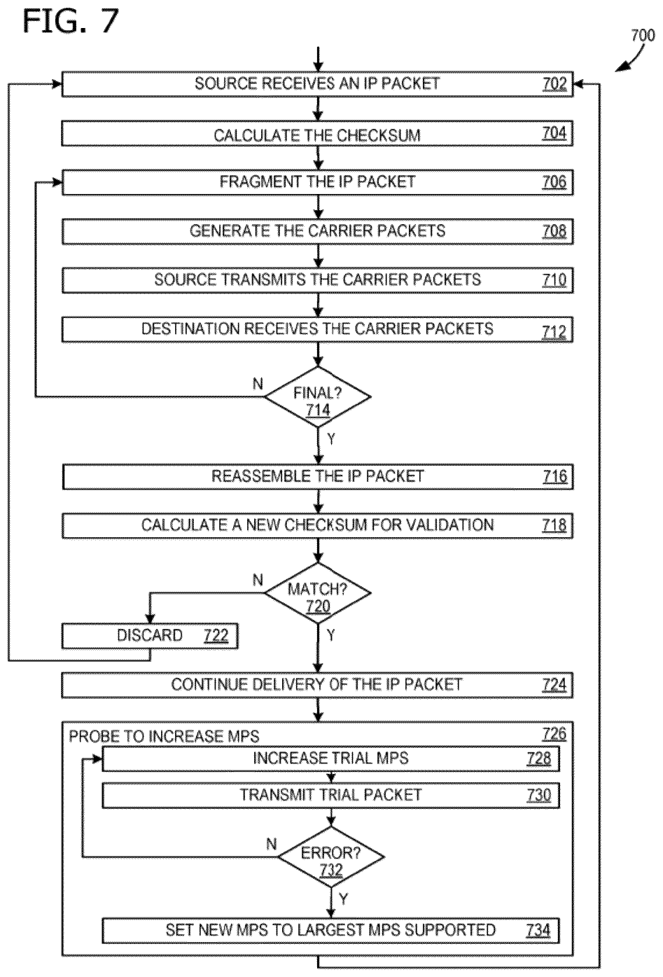

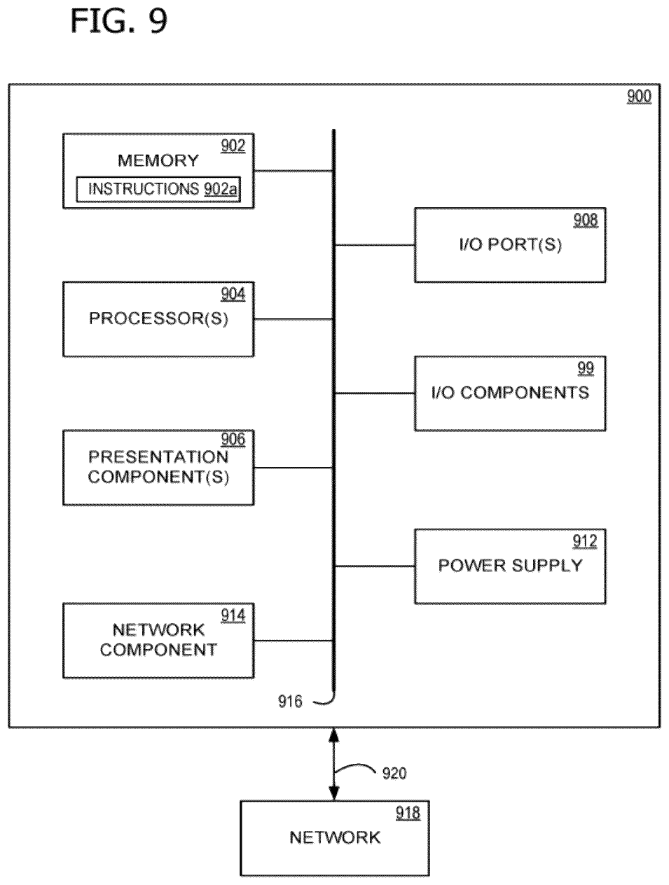

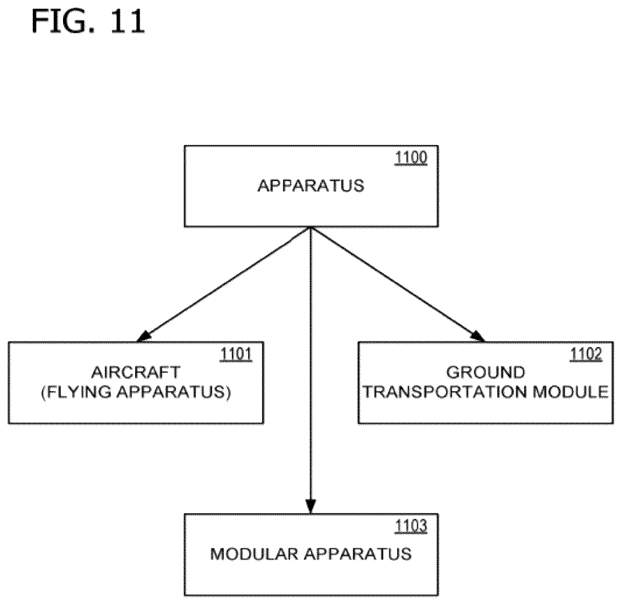

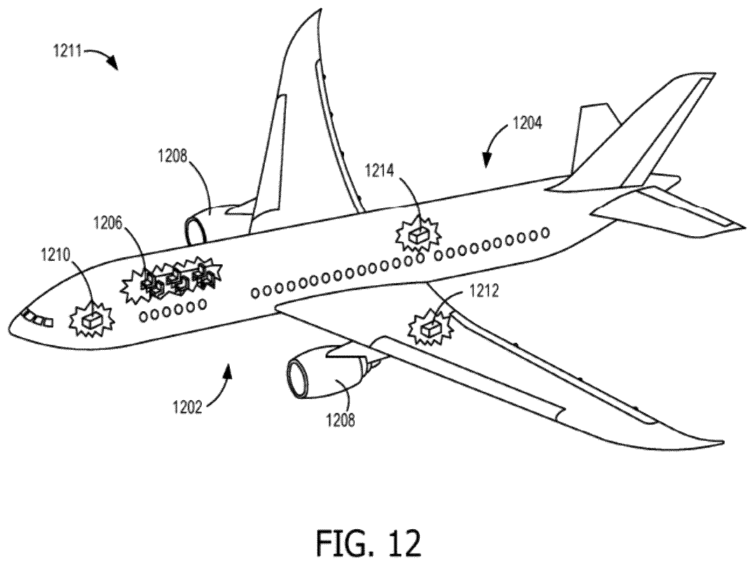

Referring more particularly to the drawings, FIG. 1 illustrates an arrangement 100 that advantageously adapts internet protocol (IP) for heterogeneous internetworks. The arrangement 100 includes a plurality of nodes including a source node (such as, e.g., the source client 110) and a destination node (such as, e.g., the destination client 140 or, in some circumstances, the destination client 130). In some embodiments the plurality of nodes further includes one or more intermediate node(s) (such as, e.g., the client). The plurality of nodes define a network communication path for one or more IP packets. The operation of the arrangement 100 is described in further detail in relation to FIG. 7 (showing a flowchart 700). In some examples, the arrangement 100 is implemented using one or more computing devices 900 of FIG. 9 and deployed on an apparatus 1100, such as a flying apparatus 1101, described in further detail in relation to FIGS. 11 and 12. Deployment on the apparatus 1100 may be for exclusively on-board communications and/or for apparatus 1100 to communicate with external networks.

Mobile network platforms and devices (e.g., aircraft of various configurations, such as the flying apparatus 1101, terrestrial vehicles, seagoing vessels, enterprise wireless devices, pedestrians with cell phones, etc.) communicate with networked correspondents over multiple access network data links and configure mobile routers to connect end user networks. Some examples of the arrangement 100 enable mobile nodes to coordinate with a network-based mobility service and/or with other mobile node peers.

In the illustrated example of FIG. 1, the source client 110 is transmitting data, using packets, to a destination client 130 over a heterogeneous internetwork 120 that includes at least networks 122a-122c. An end user network (EUN) 104, such as a WiFi network, is “downstream” from the perspective of the source client 110 and serves a plurality of downstream-dependent devices 102a-102c that are joined to the rest of the network by the source client 110. The arrangement 100 includes multiple adaptation layer interfaces, which are identified according to the roles they provide: a source interface 112 at the source client 110, and a destination interface 132 at the destination client 130.

In some examples, each of the source interface 112 and the destination interface 132 comprise an overlay multilink network interface (OMNI) that embodies the OMNI adaptation layer (OAL). An OMNI interface (e.g., the source interface 112 and the destination interface 132) provide a computer networking interface abstraction that introduces an adaptation layer between a network layer 304 (described in further detail in relation to FIG. 3A) and a data link layer seen as heterogeneous underlying interfaces with diverse properties. Within the OMNI interface, an adaptation layer 303 (described in further detail in relation to FIG. 3A) is inserted and operates below the network layer 304 but above the (data link layer) heterogeneous underlying interfaces. By using the adaptation layer interfaces, full packet size diversity is supported.

This solves the problem of how to find robust and efficient packet sizes that are the best fit for each network path under dynamically changing network conditions, and to interconnect diverse networks through a virtual bridging abstraction rather than network layer routing. This facilitates joining the networks of large corporations and their acquired subsidiaries without having to refactor each network to render them homogeneous. Examples of the arrangement 100 uses IP version 6 (IPv6) encapsulation, fragmentation, and reassembly with larger variable-length cells over heterogeneous underlying networks, such as the heterogeneous internetwork 120, to permit the use of larger packets over a network that has a smaller maximum transmission unit (MTU), which is the MPS plus the length of any headers and other overhead. This approach may be used for any heterogeneous data communication scenario, including cellular, WiFi, very high frequency (VHF), Ethernet, and satellite communications (satcom).

Further advantages include that the source interface 112 is able to provide the capability for providing global Internetworking support for a plurality of downstream-dependent devices, so that each downstream-dependent device may benefit without requiring the adaptation layer capability itself. This reduces the cost of new internet of things (IoT) end devices and preserves the value of investment in already deployed IoT devices. For example, the device 102a, the device 102b, and the device 102c are downstream-dependent IoT devices of source client 110 with source interface 112. Thus, the source interface 112 is able to provide the advantageous capabilities described herein for data traffic for all of the devices 102a-102c.

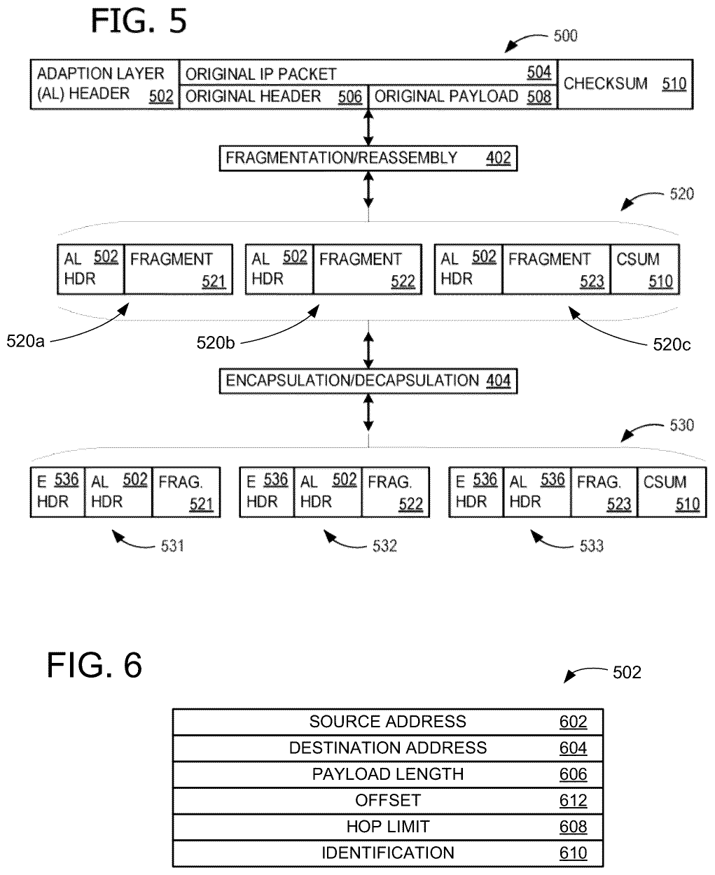

The source interface 112 provides an adaptation sublayer service whereby an incoming original IP packet 504 from an original source (e.g., one of the devices 102a-102c) is wrapped in a new header (IPv6, in some examples) and subject to local fragmentation and (remote) reassembly at the destination interface 132. The original IP packet 504 is described in further retail in relation to FIG. 5. In some examples, the source interface 112 sends IPv6 Neighbor Discovery (ND) messages (e.g., Router Solicitation, Router Advertisement, Neighbor Solicitation, Neighbor Advertisement, and Redirect) over available underlying interfaces IF 114a, IF 114b, and IF 114c, and the network 122a, the network 122b, and the network 122c, to first hop segment (FHS) proxy/servers, such as an FHS 124a, an FHS 124b, and an FHS 124c, using any necessary encapsulations. The IPv6 ND messages traverse the networks 122a-122c until they reach an FHS 124a-124c, which return responses and/or forward proxy versions via a segment routing topology (SRT) 126 to last hop segment (LHS) proxies/servers, such as an LHS 128a, an LHS 128b, and an LHS 12bc near the target destination client 130. In some examples, the destination client 130 uses underlying interfaces IF 134a, IF 134b, and IF 134c. In some examples, a hop limit is not decremented for encapsulation. In some examples, the source interface 112 is implemented in an FHS device, and the destination interface 132 is implemented in an LHS device.

After the initial ND message exchange, the source interface 112 (and/or downstream-dependent IoT devices 102a-102c using the EUN 104) is able to send packets (e.g., the original IP packet 504) to the destination client 130 via the source client 110 using the source interface 112 and the destination interface 132. The source interface 112 forwards the packets via one or more of FHSs 124a-124c, which forwards them over the SRT 126, which forwards them to one or more of LHSs 128a-128c, which then delivers them to the destination interface 132 at the destination client 130.

In some examples, the source interface 112 and the destination interface 132 observe the link nature of tunnels. In some examples, IPv6 underlying interfaces configure a minimum MTU of 1280 octets, and IP version 4 (IPv4) underlying interfaces configure a minimum MTU of 68 octets. In some examples, the source interface 112 prepends an IPv6 encapsulation header 536, which is described in further detail in relation to FIG. 5. A 16-bit payload length field in the encapsulation header 536 limits the largest size of the original IP packet 504 to (2\hat{ }16−1)=65,535 octets. If a received original IP packet is larger than this, the source interface 112 will return a packet too big (PTB) error message, in some examples.

This is also the largest size that the source interface 112 and the destination interface 132 are able to accommodate with IPv6 fragmentation. The source interface 112 therefore sets an MTU of 65,535 octets or less to support assured downstream delivery of packets. The largest MPS supported is the largest MTU supported, minus the length of overhead, such as the encapsulation header 536 and any other headers or overhead. The source interface 112 then employs encapsulation to transform the original IP packet 504 into a plurality of carrier packets 530 (including carrier packets 531-533), as described in further detail in relation to FIG. 5.

The carrier packets 531-533 travel over one or more of the underlying networks 122a-122c and the SRT 126 until reaching the destination interface 132. In some configurations, the destination client 130 is not the final destination of data traffic from one or more of the devices 102a-102c, but is instead an intermediate node. The final destination may instead be a further destination client 140, across a network 122d. In such configurations, the heterogeneous internetwork 120 further comprises network 122d, and the destination interface 132 is actually an intermediate interface. That is, the destination interface 132 is a destination relative to the source interface 112, but is a source relative to a destination interface 142 at the destination client 140. In such example, the destination interface 132 will also have the functionality described herein for the source interface 112, to enable the destination interface 132 to act as a source interface. A similar FHS/SRT/LHS configuration may be used between the destination client 130 and the destination client 140 as is used between the source client 110 and the destination client 130.

When the destination interface 132 receives each of the carrier packets 531-533, it discards encapsulation header 536 and performs defragmentation to reassemble the original IP packet 504. If the destination client 130 is the final destination, the destination interface 132 also removes an adaptation layer header 502, which is described in further detail in relation to FIGS. 5 and 6, and delivers the original IP packet 504 to the network layer 304. If the destination client 130 is an intermediate node, then the destination interface 132 re-encapsulates each fragment 520 into a new set of carrier packets suitable for the network 122d.

In some examples, the source interface 112 initially sets an MPS of 400 octets and uses active probing, as described in relation to FIG. 7. By actively probing the downstream portion of the heterogeneous internetwork 120, the source interface 112 may be able to increase the MPS, and thus the MTU. This reduces number of carrier packets needed to send fragments of the original IP packet 504. In some examples, the probed MPS may become large enough to allow the entire original IP packet to fit inside a single carrier packet.

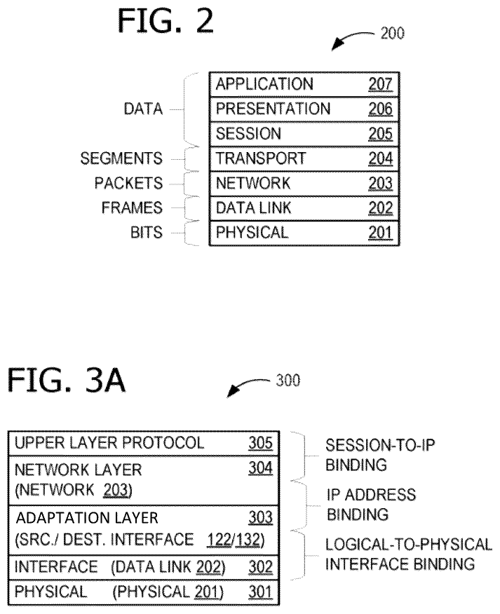

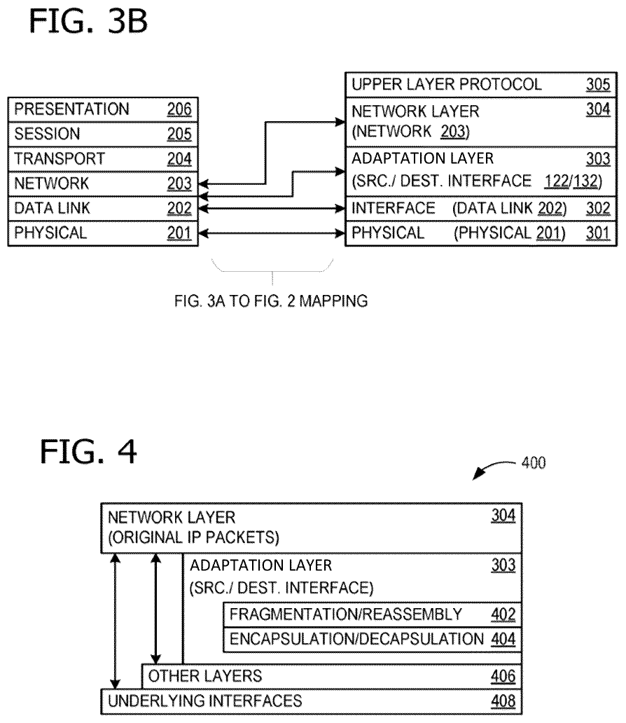

FIG. 2 shows a representative seven-layer network model 200. A physical layer 201 (“layer 1”) represents the bits of data to be transmitted, for example using a cable. A data link layer 202 (“layer 2”) represents data frames, for example, for media access control (MAC) and switching. A network layer 203 (“layer 3”) represents packets operated upon by routers, such as IPv4 packets and IPv6 packets. A transport layer 204 represents segments, port numbers, and protocols, for example transmission control protocol (TCP) and user datagram protocol (UDP). A session layer 205 (“layer 5”), a presentation layer 206 (“layer 6”), and an application layer 207 (“layer 7”) are the data layers. The session layer 205 includes session initiation protocol (SIP), synchronize (Syn) and acknowledge (Ack) signaling. The presentation layer 206 may implement encryption, decryption, and compression/decompression. The application layer 207 implements hypertext transfer protocol (HTTP) and file transfer protocol (FTP).

FIG. 3A illustrates an adaptation layer model 300 as may be used in the arrangement 100 of FIG. 1, in accordance with an example. The adaptation layer model 300 has a physical layer 301, an interface layer 302, the adaptation layer 303, a network layer 304, and an upper layer protocol 305. The source interface 112, the destination interface 132, and the destination interface 142 operate at the adaptation layer 303 and are able to send/receive original IP packets to/from underlying interfaces while including/omitting various encapsulations. In some examples, the network layer 304 is able to access the interface layer 302, bypassing the adaptation layer 303 (and thus the source interface 112, the destination interface 132, and the destination interface 142).

FIG. 3B maps elements of the adaptation layer model 300 to elements of the seven-layer network model 200. As can be seen in FIG. 3B, the physical layer 301 of the adaptation layer model 300 maps to the physical layer 201 of the seven-layer network model 200, the interface layer 302 maps to the data link layer 202, and the network layer 304 of the adaptation layer model 300 maps to the network layer 203 of the seven-layer network model 200. The adaptation layer 303 has no direct correlation in the seven-layer network model 200, because it would be between the data link interface layer 302 of the seven-layer network model 200 and the network layer 203 of the seven-layer network model 200.

FIG. 4 illustrates further detail of network layering for the adaptation layer model 300. As described in further detail in relation to FIG. 5, fragmentation/defragmentation 402 occurs within the adaptation layer 303, as well as encapsulation/decapsulation 404. Other layers 406, representing the interface layer 302 and the physical layer 301 and underlying interfaces 408 are shown as reachable by the network layer 304.

FIG. 5 illustrates fragmenting an adaptation layer packet 500 or an original IP packet 504 into a plurality of fragments 520, and generating the plurality of carrier packets 530. The original IP packet 504, as received by the source interface 112, includes an original header 506 and an original payload 508. The fragmentation, described herein which produces the fragment payloads 521-523, may be accomplished in multiple ways. These include: (option 1) fragment the entire original IP packet 504 into the fragment payloads 521-523, using the size of the entire original IP packet 504 as a fragmentation trigger; (option 2) fragment the entire original IP packet 504 into the fragment payloads 521-523, using the size of the original payload 508 as a fragmentation trigger, and assuming a worst case for the size of the original header 506; and (option 3) fragment only the original payload 508 into the fragment payloads 521-523, using the size of the original payload 508 as a fragmentation trigger, and discarding the original header 506.

Option 1 is described below in detail. Options 2 and 3 are straightforward adjustments. For option 2, the following mentions of determining whether to fragment the original IP packet 504 is instead accomplished by using the size of the original payload 508 in place of the size of the original IP packet 504. For option 3, the following mentions of fragmenting the original IP packet 504 into the fragment payloads 521-523 is instead accomplished by fragmenting only the original payload 508.

The source interface 112 generates an adaptation layer packet 500 comprising the adaptation layer header 502 prepended to the original IP packet 504, and (in some embodiments) appended with a checksum 510, as shown. As shown, the original IP packet 504 comprises the original header 506 and the original payload 508. The checksum 510 is calculated using at least the original payload 508, and is used to verify that reassembly by the destination interface 132 produces a correct result. In some examples, the checksum 510 is calculated using both the adaptation layer header 502 and the entire original IP packet 504. In some examples, the checksum 510 is calculated using both the adaptation layer header 502 and the entire original IP packet 504. In some examples, the checksum 510 is calculated using the entire original IP packet 504. In some examples, the checksum 510 comprises two octets. In some examples, the checksum 510 comprises a Fletcher checksum.

In the illustrated example, the size of the original IP packet 504 exceeds the current MPS being used by source interface 112. The current MPS may be the initial MPS or, after starting probing, may be a larger MPS than the initial MPS. The fragmentation/defragmentation 402 uses the size of the entire original IP packet 504 as a fragmentation trigger or, for option 2 as described above, uses the size of the original payload 508 as the fragmentation trigger and assuming a worst-case value (largest expected size) for the size of the original header 506. For option 3, the fragmentation/defragmentation 402 uses the size of the original payload 508 as the fragmentation trigger, since the original header 506 will be discarded. Some examples use MTU in place of MPS for the fragmentation trigger determination, which is equivalent, because there is a fixed mathematical relationship between MPS and MTU.

In some embodiments, the source interface 112 (e.g., the source OMNI interface) receives an original IP packet 504 from the network layer 304 and appends an adaptation layer header 502 to the original IP packet 504 to create an adaptation layer packet 500. The source interface 112 may then fragment the adaptation layer packet 500 into fragments 520 (or fragment packets) having a size less than or equal to the maximum payload size. Each fragment 520 (or fragment packet) includes a respective adaptation layer header 502 and a respective portion of the original IP packet 504. The source interface 112 may then encapsulate each fragment 520 (or each fragment packet) into a corresponding carrier packet 530. For example, the source interface 112 may append a first encapsulation header 536 to a first fragment 520 (or a first fragment packet), may append a second encapsulation header 536 to a second fragment 520 (or a second fragment packet), and so on for each of fragments (or fragment packets) formed from the original IP packet 504. The source interface 112 may provide the carrier packets 530 to the next adaptation layer hop via an underlying data link layer interface. A fragment 520 may be referred to as a fragment packet, an adaptation layer fragment, or an adaptation layer fragment packet.

The fragmentation/defragmentation 402 fragments the adaptation layer packet 500 or the original IP packet 504 (or for option 3, fragments only the original payload 508) into the plurality of fragments 520, such as fragment 520a, fragment 520b, fragment 520c, etc. Each fragment of the fragments 520 (e.g., fragment 520a, fragment 520b, fragment 520c, etc.) includes an adaptation layer header 502 and a fragment payload (e.g., fragment payload 521, fragment payload 522, fragment payload 523, etc.) such that each fragment (or each fragment payload 521-523) of the plurality of fragments 520 does not exceed the current MPS. The fragment payload 521 is the initial fragment payload, and may include at least some of the original header 506. The fragment payload 521 is followed by the fragment payload 522, which is followed by the final fragment payload 523. In some examples, each non-final fragment payload (e.g., the fragment payload 521 and 522) is at least as large as the current MPS, while the final fragment (e.g., the fragment payload 523) may be smaller than the current MPS. Although three fragment payloads are shown, it should be understood that this number is notional, and that a different number of fragment payloads may be used. Each of the fragment payloads 521-523 is prepended by the adaptation layer header 502. The final fragment payload (the fragment payload 523 in the illustrated example) is also appended with the checksum 510.

A carrier packet 530 is formed by appending an encapsulation header 536 (e.g., a data link layer encapsulation header) to a fragment 520. In this way, the fragment 520 (e.g., the adaptation layer fragment) becomes the payload of the carrier packet 530. For example, and as shown, a first carrier packet 531 includes the fragment 520a (which includes fragment payload 521 and a first adaptation layer header 502), a second carrier packet 532 includes the fragment 520b (which includes fragment payload 522 and a second adaptation layer header 502), a third carrier packet 533 includes the fragment 520c (which includes fragment payload 523 and a third adaptation layer header 502), and so on.

In some alternative embodiments, the encapsulation/decapsulation 404 encapsulates each of the fragments 520 (e.g., combinations of the prepended fragment payloads 521-523) by further prepending the encapsulation header 536. In some examples, the encapsulation header 536 and/or the adaptation layer header 502 has its source address set to the IP address of the source interface 112 and its destination address set to the IP address of the destination interface 132. This produces the illustrated plurality of carrier packets 530, where the illustrated order for each of the carrier packets 531-533 is: the encapsulation header 536, the adaptation layer header 502, and the fragment payloads (e.g., the specific one of the fragment payloads 521-523). The first carrier packet 531 is followed by the second carrier packet 532, which is followed by the third and final (in this example) carrier packet 533.

In some embodiments, the carrier packet 533 also has the checksum 510 following the fragment payload 523. Each of the carrier packets 531-533 does not exceed the MTU of the immediately downstream segment of heterogeneous internetwork 120. That is each of the fragment payloads 521-523 (and including the checksum 510 appended to the fragment payload 523) does not exceed the current MPS. The current MPS, plus the size of the overhead (e.g., the size of the combination of the encapsulation header 536 with the adaptation layer header 502) does not exceed the MPS of the immediately downstream segment of heterogeneous internetwork 120.

This, as described thus far in relation to FIG. 5, is fragmentation and encapsulation, moving from the top of FIG. 5 to the bottom. Decapsulation and reassembly is the reverse, moving from the bottom of FIG. 5 to the top.

When the network layer 304 forwards the original IP packet 504 into the source interface 112, the source interface 112 creates adaptation layer packet 500. In some examples, the adaptation layer header 502 is compressed For example, the adaptation layer header 502 may be compressed after fragmentation. The encapsulated fragments in the carrier packets 531-533 are forwarded over an underlying interface. In some examples, a UDP header is also used, for example, if network address translation (NAT) might be present in the internetwork. When a UDP header is used, a UDP checksum may also be used. In some examples, additional encapsulation sublayer headers are used.

In some embodiments, for carrier packets undergoing re-encapsulation (e.g., when the destination client 130 is an intermediate node in some embodiments) the header source address is set to the IP address of the destination interface 132 and the header destination address set to the IP address of the destination interface 142. In such examples, a hop limit in the adaptation layer header 502 is decremented, and the carrier packet is discarded when the hop limit reaches zero.

The underlying interfaces may connect directly to physical media on the local platform (e.g., a notebook computer with WiFi, etc.), although in some configurations the physical media may be hosted on a separate LAN node. In such a case, a point-to-point tunnel (at a layer below the underlying interface) to the node hosting the physical media may be established. In some examples, additional encapsulations may also be applied at the underlying interface layer (e.g., as for a tunnel virtual interface) such that carrier packets would appear double-encapsulated on a LAN.

In some embodiments, when the destination interface 132 receives a carrier packet from an underlying interface, it discards the encapsulation header 536 and examines the adaptation layer header 502 of the adaptation layer packet 500. If the adaptation layer packet 500 is addressed to a different node, the destination interface 132 (acting as an intermediate interface) re-encapsulates and forwards the carrier packet. When reassembly is complete, the destination interface 132 (or 142) verifies the checksum 510 and discards the received ones of fragment payloads 512-523 if the checksum 510 is incorrect. If adaptation layer packet 500 is accepted (e.g., the checksum 510 is verified), the destination interface 132 (or 142) removes the adaptation layer header 502 from each of the fragment payloads 521-523 and delivers the original IP packet 504 to the network layer 304.

FIG. 6 illustrates further detail for the adaptation layer header 502, which in some examples, comprises an IPv6 header. The adaptation layer header 502 has a source address 602, which may be set to the IP address of the source interface 112 and a destination address 604, which may be set to the IP address of the destination interface 132. A payload length field 606 has a value set to the size (length) of the original IP packet 504 (or the size of the original payload 508 for option 3) plus the checksum 510. A hop limit 608 may be set to a value sufficient to enable loop-free forwarding over multiple concatenated link segments.

In embodiments, the adaptation layer header 502 further includes an offset field 612. The offset field 612 provides an indicator of a relative fragment offset for the respective fragment payload. That is, when the adaptation layer packet 500 or the original IP packet 504 is fragmented into fragments 520, the offset field 612 in the respective adaptation layer header 502 for each fragment (e.g., fragment 520a, fragment 520b, fragment 520c, etc.) provides an offset amount that reflects which portion of the original IP packet 504 is included in the respective fragment payload (e.g., fragment payload 521, fragment payload 522, fragment payload 523, etc.). Thus, e.g., the offset field 612 permits each respective fragment payload of the fragments 520 to be mapped back to the original IP packet 504 which, in turn, enables reassembly of the original IP packet 504 from the fragment payloads of the fragments 520.

As an example, assume the MPS is 1,000 octets, and the adaptation layer packet 500 is 3,000 octets. In this case, the first fragment 520a may be 1,000 octets in size with an offset of zero, the second fragment 520b may be 1,000 octets in size with an offset of 1,000, and the third fragment 520c may be 1,000 octets in size with an offset of 2,000. Thus, the receiver can determine, by examining the size and/or offset of each fragment, where to place each fragment 520 in the reassembly buffer. After all fragments 520 are received by the receiver, the reassembly process terminates, and the original IP packet 504 can be reconstructed from the fragments 520 and delivered to the network layer of the destination.

A carrier packet could traverse multiple SRT segments with intermediate nodes performing decapsulation and re-encapsulation (and decrementing the hop limit 608). In some examples, a 32-bit packet identification 610 is used. In some examples, “Type of Service/Traffic Class” and/or “Congestion Experienced” values are copied from the original header 506 into the adaptation layer header 502.

With reference now to FIG. 7, a flowchart 700 illustrates a method of adapting IP for heterogeneous internetworks as may be used with the arrangement 100. In some examples, the operations illustrated for the flowchart 700 are performed, at least in part, by executing instructions 902a (stored in the memory 902) by the one or more processors 904 of the computing device 900 of FIG. 9, when deployed on the apparatus 1100 of FIG. 11. The flowchart 700 commences with operation 702, which includes receiving the original IP packet 504 into the source interface 112. The original IP packet 504 comprises the original header 506 and the original payload 508, and a size of the original IP packet 504 exceeds a first MPS (e.g., the current MPS). In some examples, the source interface 112 comprises an OAL interface.

In some examples, operation 702 is part of a larger activity that includes receiving, by the source interface 112, IP packets (e.g., multiple ones of the original IP packet 504) from a plurality of the downstream-dependent devices 102a-102c that are connected to the rest of the internetwork by the source interface 112. In such examples, the following operations 704-710 are also part of the larger activity and include, based on at least the first MPS (e.g., the current MPS) and sizes of payloads of the IP packets from the plurality of the downstream-dependent devices 102a-102c, fragmenting the IP packets from the plurality of downstream-dependent devices 102a-102c into sets of carrier packets and transmitting the sets of carrier packets.

Operation 704 calculates the checksum 510. The calculation of the checksum 510 includes at least the original payload 508. In some examples, the calculation of the checksum 510 further includes at least the original header 506 (e.g., includes the original IP packet 504). In some examples, the calculation of the checksum 510 further includes the adaptation layer header 502. In some examples, the calculation of the checksum is performed on a concatenation of the adaptation layer header 502 and the original payload 508.

Operation 706 includes, based on at least the first MPS and the size of the original IP packet 504, fragmenting the original IP packet 504 into the plurality of fragments 520, wherein each fragment payload 521-523 of the plurality of fragments 520 does not exceed the first MPS. Operation 708 generates the plurality of carrier packets 530, wherein each carrier packet 531-533 comprises the encapsulation header 536 and one fragment payload of the plurality of fragments 520. In some examples, the encapsulation header 536 comprises the payload length field 606, which may be 16-bits. In some examples, each carrier packet 531-533 comprises the adaptation layer header 502. In some examples, the adaptation layer header 502 is located between the encapsulation header 536 and the fragment payload within each carrier packet. In some examples, the adaptation layer header comprises an IPv6 header. Some examples include copying information from the original header into the adaptation layer header, for example copying “Type of Service/Traffic Class” and/or “Congestion Experienced” from the original header 506 into the adaptation layer header 502. In some examples, operation 708 further includes appending the checksum 510 within a carrier packet (e.g., the carrier packet 533) of the plurality of carrier packets 530.

Operation 710 transmits the plurality of carrier packets 530 over the heterogeneous internetwork 120 to the destination interface 132. In some examples, the destination interface 132 comprises an OAL interface. In operation 712, the destination interface 132 receives the plurality of carrier packets 530.

Decision operation 714 determines whether the destination interface 132 is the final (ultimate) destination for the original IP packet 504, or instead is an intermediate interface (e.g., the destination node is an intermediate node). If the destination interface 132 is only an intermediate interface, the flowchart returns to operation 706 and the destination interface 132 assumes the role of the source interface 112. The next pass-through operation 706 is, based on at least a second MPS (e.g., the current MPS for the next segment of the heterogeneous internetwork 120) and the size of the original IP packet 504, fragmenting the original IP packet 504 into a second plurality of fragments 520, wherein each fragment payload of the second plurality of fragments 520 does not exceed the second MPS.

The next pass-through operation 708 includes generating a second plurality of carrier packets, wherein each carrier packet comprises an encapsulation header and one fragment payload of the second plurality of fragments 520, and the next pass-through operation 710 transmits, by the intermediate interface (e.g., the destination interface 132), the second plurality of carrier packets 530 over a second heterogeneous internetwork to a second destination interface 542.

When the final destination is reached, operation 716 reassembles the original IP packet 504 from the plurality of fragments 520. Operation 718 calculates a new checksum based on the reassembled version of the original IP packet 504. After reassembling the original IP packet 504, decision operation 720 determines whether the newly calculated checksum (from operation 718) matches the checksum 510 included in the carrier packet 533. If not, operation 722 discards the reassembled version of the original IP packet 504. That is, operation 722 includes, based on at least determining that the newly calculated checksum does not match the checksum included in the carrier packet 533, discarding the original payload 508. The flowchart 700 then returns to operation 702.

Otherwise, if the checksum 510 is validated, operation 724 includes, based on at least determining that the newly calculated checksum matches the checksum 510 included in the carrier packet 533, continuing delivery of the original payload 508 to the network layer 304 (e.g., within the original IP packet 504).

In operation 726, the source interface 112 performs probing to determine a largest MPS supported by the downstream network. In some examples, probing comprises iteratively performing operations 728-732 until receiving an indication that a trial packet is too large, and then proceeds to operation 734.

Operation 728 increases a trial MPS, first from the current MPS that had been used for the fragmentation measure, and then from a prior trial MPS. Operation 730 transmits a trial packet over the heterogeneous internetwork, and waits for an indication of whether the trial MPS was received by the destination interface. In the trial packet, a size of the trial payload matches the trial MPS. Decision operation 732 makes the determination of whether the most recently-attempted trial MPS is too large. If not, operation 726 returns to operation 728 to try an even larger trial MPS. However, if the recently-attempted trial MPS is too large, operation 734 sets new current MPS to the largest MPS supported. The largest MPS supported is determined to be the largest trial MPS for which the indication that a trial carrier packet is too large is not received, but rather an acknowledgement from the destination interface is received instead. A larger MPS reduces a count of fragments required for reassembling an IP packet, improving transmission efficiency.

In some examples, the indication that a trial packet is too large comprises a received error message, such as a PTB message. In some examples, the indication that a trial packet is too large comprises failing to receive an acknowledgement that the trial packet was received, for example, within a timeout period. In some examples, the trial packet comprises a trial payload, for example, in an IP packet generated for the purpose of probing. This prevents the loss of actual data when performing probing. In such examples, operation 730 includes generating, by the source interface 112, the trial packet, and operation 726 includes performing the probing with an IP packet generated for the purpose of probing. In some examples, probing involves probing different internetwork paths individually, and finding a path-specific MPS to use in operation 706.

In some examples, the source interface 112 performs the probing with an IP packet received from a downstream-dependent device (e.g., real data), and so the trial packet comprises an IP packet received from a downstream-dependent device.

The flowchart 700 returns to operation 702 to fragment and encapsulate another original IP packet 504.

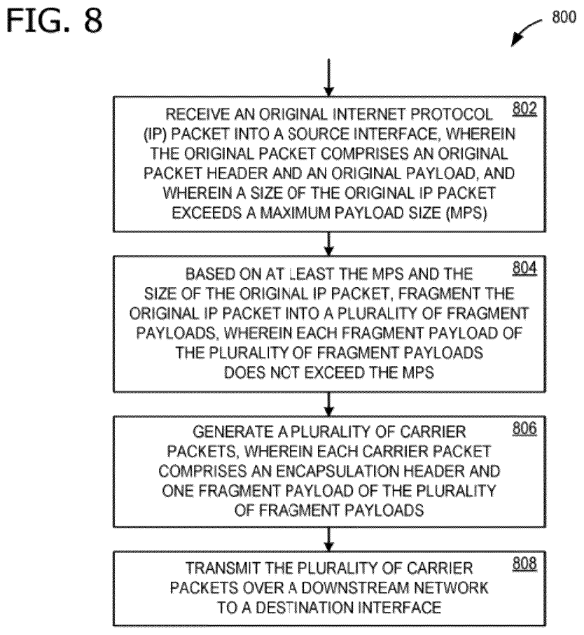

FIG. 8 is a flowchart 800 illustrating a method of adapting IP for heterogeneous internetworks. In some examples, the operations illustrated for the flowchart 800 are performed, at least in part, by executing instructions 902a (stored in the memory 902) by the one or more processors 904 of the computing device 900 of FIG. 9, when deployed on the apparatus 1100 of FIG. 11. The flowchart 800 commences with operation 802, which includes receiving an original IP packet into a source interface, wherein the IP packet comprises an original header and an original payload, and wherein a size of the original IP packet exceeds an MPS.

Operation 804 includes, based on at least the MPS and the size of the original IP packet, fragmenting the original IP packet into a plurality of fragment payloads, wherein each fragment payload of the plurality of fragment payloads does not exceed the MPS. Operation 806 includes generating a plurality of carrier packets, wherein each carrier packet comprises an encapsulation header and one fragment payload of the plurality of fragment payloads. Operation 808 includes transmitting the plurality of carrier packets over a downstream network to a destination interface.

With reference now to FIG. 9, a block diagram of the computing device 900 suitable for implementing various aspects of the disclosure is described. In some examples, the computing device 900 includes one or more processors 904, one or more presentation components 906 and the memory 902. The disclosed examples associated with the computing device 900 are practiced by a variety of computing devices, including personal computers, laptops, smart phones, mobile tablets, hand-held devices, consumer electronics, specialty computing devices, etc. Distinction is not made between such categories as “workstation,” “server,” “laptop,” “hand-held device,” etc., as all are contemplated within the scope of FIG. 9 and the references herein to a “computing device.” The disclosed examples are also practiced in distributed computing environments, where tasks are performed by remote-processing devices that are linked through a communications network. Further, while the computing device 900 is depicted as a seemingly single device, in one example, multiple computing devices work together and share the depicted device resources. For instance, in one example, the memory 902 is distributed across multiple devices, the processor(s) 904 provided are housed on different devices, and so on.

In one example, the memory 902 includes any of the computer-readable media discussed herein. In one example, the memory 902 is used to store and access instructions 902a configured to carry out the various operations disclosed herein. In some examples, the memory 902 includes computer storage media in the form of volatile and/or nonvolatile memory, removable or non-removable memory, data disks in virtual environments, or a combination thereof. In one example, the processor(s) 904 includes any quantity of processing units that read data from various entities, such as the memory 902 or input/output (I/O) components 910. Specifically, the processor(s) 904 are programmed to execute computer-executable instructions for implementing aspects of the disclosure. In one example, the instructions are performed by the processor, by multiple processors within the computing device 900, or by a processor external to the computing device 900. In some examples, the processor(s) 904 are programmed to execute instructions such as those illustrated in the flowcharts discussed below and depicted in the accompanying drawings.

The presentation component(s) 906 present data indications to an operator or to another device. In one example, presentation components 906 include a display device, speaker, printing component, vibrating component, etc. One skilled in the art will understand and appreciate that computer data is presented in a number of ways, such as visually in a graphical user interface (GUI), audibly through speakers, wirelessly between the computing device 900, across a wired connection, or in other ways. In one example, presentation component(s) 906 are not used when processes and operations are sufficiently automated that a need for human interaction is lessened or not needed. I/O ports 908 allow the computing device 900 to be logically coupled to other devices including the I/O components 910, some of which is built in. Implementations of the I/O components 910 include, for example but without limitation, a microphone, keyboard, mouse, joystick, game pad, satellite dish, scanner, printer, wireless device, etc.

The computing device 900 includes a bus 916 that directly or indirectly couples the following devices: the memory 902, the one or more processors 904, the one or more presentation components 906, the input/output (I/O) ports 908, the I/O components 910, a power supply 912, and a network component 914. The computing device 900 should not be interpreted as having any dependency or requirement related to any single component or combination of components illustrated therein. The bus 916 represents one or more busses (such as an address bus, data bus, or a combination thereof). Although the various blocks of FIG. 9 are shown with lines for the sake of clarity, some implementations blur functionality over various different components described herein.

In some examples, the computing device 900 is communicatively coupled to a network 918 using the network component 914. In some examples, the network component 914 includes a network interface card and/or computer-executable instructions (e.g., a driver) for operating the network interface card. In one example, communication between the computing device 900 and other devices occur using any protocol or mechanism over a wired or wireless connection 920. In some examples, the network component 914 is operable to communicate data over public, private, or hybrid (public and private) using a transfer protocol, between devices wirelessly using short range communication technologies (e.g., near-field communication (NFC), Bluetooth® branded communications, or the like), or a combination thereof.

Although described in connection with the computing device 900, examples of the disclosure are capable of implementation with numerous other general-purpose or special-purpose computing system environments, configurations, or devices. Implementations of well-known computing systems, environments, and/or configurations that are suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, holographic device, and the like. Such systems or devices accept input from the user in any way, including from input devices such as a keyboard or pointing device, via gesture input, proximity input (such as by hovering), and/or via voice input.

Implementations of the disclosure are described in the general context of computer-executable instructions, such as program modules, executed by one or more computers or other devices in software, firmware, hardware, or a combination thereof. In one example, the computer-executable instructions are organized into one or more computer-executable components or modules. Generally, program modules include, but are not limited to, routines, programs, objects, components, and data structures that perform particular tasks or implement particular abstract data types. In one example, aspects of the disclosure are implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein. In implementations involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. In one example, computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium used to store information for access by a computing device. In contrast, communication media typically embody computer readable instructions, data structures, program modules, or the like in a modulated data signal such as a carrier wave or other transport mechanism and include any information delivery media.

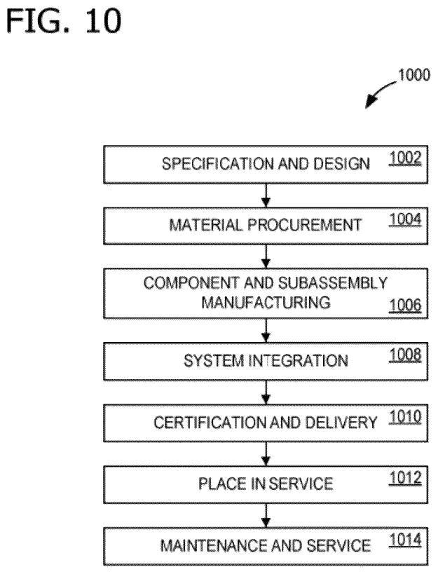

Some examples of the disclosure are used in manufacturing and service applications as shown and described in relation to FIGS. 10-12. Thus, examples of the disclosure are described in the context of an apparatus of manufacturing and service method 1000 shown in FIG. 10 and apparatus 1100 shown in FIG. 11. In FIG. 11, a diagram illustrating an apparatus manufacturing and service method 1000 is depicted in accordance with an example. In one example, during pre-production, the apparatus manufacturing and service method 1000 includes specification and design 1002 of the apparatus 1100 in FIG. 11 and material procurement 1004. During production, component, and subassembly manufacturing 1006 and system integration 1008 of the apparatus 1100 in FIG. 11 takes place. Thereafter, the apparatus 1100 in FIG. 11 goes through certification and delivery 1010 in order to be placed in service 1012. While in service by a customer, the apparatus 1100 in FIG. 11 is scheduled for routine maintenance and service 1011, which, in one example, includes modification, reconfiguration, refurbishment, and other maintenance or service subject to configuration management, described herein.

In one example, each of the processes of the apparatus manufacturing and service method 1000 are performed or carried out by a system integrator, a third party, and/or an operator. In these examples, the operator is a customer. For the purposes of this description, a system integrator includes any number of apparatus manufacturers and major-system subcontractors; a third party includes any number of venders, subcontractors, and suppliers; and in one example, an operator is an owner of an apparatus or fleet of the apparatus, an administrator responsible for the apparatus or fleet of the apparatus, a user operating the apparatus, a leasing company, a military entity, a service organization, or the like.

With reference now to FIG. 11, the apparatus 1100 is provided. As shown in FIG. 11, an example of the apparatus 1100 is a flying apparatus 1101, such as an aerospace vehicle, aircraft, air cargo, flying car, satellite, planetary probe, deep space probe, solar probe, and the like. As also shown in FIG. 11, a further example of the apparatus 1100 is a ground transportation apparatus 1102, such as an automobile, a truck, heavy equipment, construction equipment, a boat, a ship, a submarine, and the like. A further example of the apparatus 1100 shown in FIG. 11 is a modular apparatus 1103 that comprises at least one or more of the following modules: an air module, a payload module, and a ground module. The air module provides air lift or flying capability. The payload module provides capability of transporting objects such as cargo or live objects (people, animals, etc.). The ground module provides the capability of ground mobility. The disclosed solution herein is applied to each of the modules separately or in groups such as air and payload modules, or payload and ground, etc. or all modules.

With reference now to FIG. 12, a more specific diagram of the flying apparatus 1101 is depicted in which an implementation of the disclosure is advantageously employed. In this example, the flying apparatus 1101 is an aircraft produced by the apparatus manufacturing and service method 1000 in FIG. 10 and includes an airframe 1202 with a plurality of systems 1204 and an interior 1206. Examples of the plurality of systems 1204 include one or more of a propulsion system 1208, an electrical system 1210, a hydraulic system 1212, and an environmental system 1214. However, other systems are also candidates for inclusion. Although an aerospace example is shown, different advantageous examples are applied to other industries, such as the automotive industry, etc.

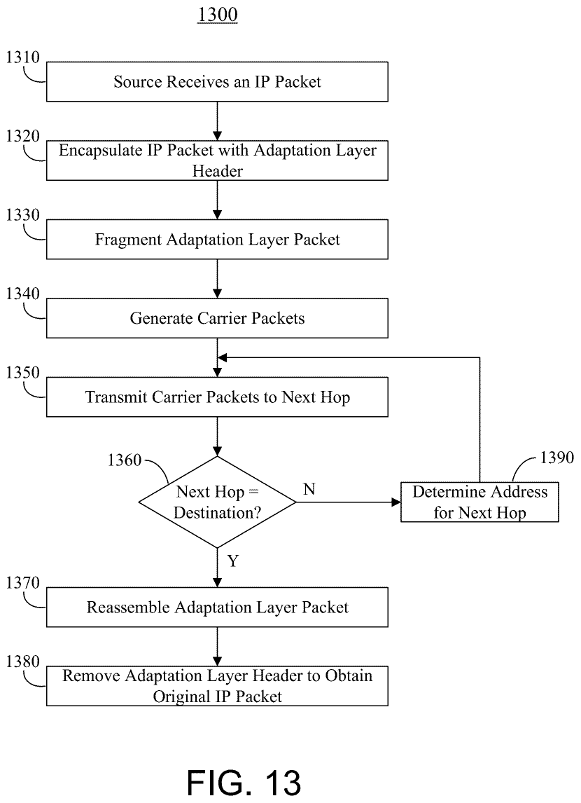

FIG. 13 is a flowchart illustrating a method 1300 of adapting IP for heterogeneous internetworks in accordance with an example. The method 1300 can generally be implemented within the arrangement 100 of FIG. 1. For example, the method 1300 can be implemented to transmit an IP packet between a source node and a destination node in a network communication path having a plurality of nodes, where each node of the plurality of nodes has an adaptation layer interface. More particularly, the method 1300 can be implemented as one or more modules as a set of logic instructions stored in a machine- or computer-readable storage medium such as RAM, ROM, programmable read-only memory (PROM), firmware, flash memory, etc., in hardware, or any combination thereof. For example, hardware implementations can include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

For example, computer program code to carry out the method 1300 can be written in any combination of one or more programming languages, including an object-oriented programming language such as Java, JavaScript, Python, C #, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 1310 provides for receiving, by a source node, an original IP packet (e.g., the original IP packet 504). Illustrated processing block 1320 provides for encapsulating the IP packet with an adaptation layer header (e.g., the adaptation layer header 502), to produce an adaptation layer packet (e.g., the adaptation layer packet 500). Illustrated processing block 1330 provides for fragmenting the adaptation layer packet (e.g., the adaptation layer packet 500) to produce fragments (e.g., the fragments 520). In embodiments this includes determining that the adaptation layer packet (e.g., the adaptation layer packet 500) or the original IP packet (e.g., the original IP packet 504) exceeds a maximum payload size (MPS) of a downstream network in the communication path; dividing the original IP packet (e.g., the original IP packet 504) into smaller fragment payloads (e.g., fragment payload 521, fragment payload 522, fragment payload 523, etc.), and encapsulating (e.g., prepending) each fragment payload with an adaptation layer header (e.g., the adaptation layer header 502). The size of the fragment payloads (e.g., fragment payload 521, fragment payload 522, fragment payload 523, etc.) is selected such that each fragment (e.g., each of the fragments 520, such as fragment 520a, fragment 520b, fragment 520c, etc.) does not exceed the MPS.

In some embodiments, the adaptation layer header (e.g., the adaptation layer header 502) that encapsulates each fragment payload is compressed, which allows for a relatively larger fragment payload with a given MPS. That is, with the size of each fragment bound by the MPS, compressing the adaptation layer header provides more room in the fragment for a larger fragment payload.

Illustrated processing block 1340 provides for generating carrier packets (e.g., carrier packets 530). In embodiments, this includes providing each of the fragments (e.g., the fragments 520, such as fragment 520a, fragment 520b, fragment 520c, etc.) as one of the carrier packets. In some embodiments, this also includes encapsulating each of the fragments (e.g., the fragments 520, such as fragment 520a, fragment 520b, fragment 520c, etc.) with an encapsulation header (e.g., the encapsulation header 536) to form the carrier packets (e.g., the carrier packets 531-533, etc.). Illustrated processing block 1350 provides for transmitting the carrier packets to the next hop (e.g., next node) in the network communication path.

Illustrated processing block 1360 provides for determining if the next hop (e.g., next node) in the network communication path is the final destination node. If no (No at block 1360), the method 1300 proceeds to block 1390. If yes (Yes at block 1360), the method 1300 continues at illustrated processing block 1370, which provides for reassembling the adaptation layer packet (e.g., the adaptation layer packet 500). In embodiments this includes taking the fragment payload from each carrier packet and, using the offset field (e.g., the value in the offset field 612) to map the respective fragment payload back to the position in the payload of the original IP packet. The offset field provides an indicator of a relative offset between the fragment payload and the original IP packet. In some embodiments, if the adaptation layer header in each of the carrier packets has previously been compressed, the adaptation layer header is decompressed before examining the offset field. In some embodiments, the adaptation layer header 502 (e.g., of each fragment 520) is decompressed before reassembly. After reassembly, the entire adaptation layer packet 500, that includes the original IP packet 504 as its payload, is formed from the fragment payloads. The header of the adaptation layer packet 500 is then discarded via decapsulation to recover the original IP packet 504. The destination interface 142 (e.g., the destination OMNI interface) may then deliver the original IP packet to the network layer. Illustrated processing block 1380 provides for removing the adaptation layer header (e.g., the adaptation layer header 502) to obtain the original IP packet (e.g., the original IP packet 504).

When the determination at block 1360 is No, the carrier packets have reached an intermediate node in the network communication path. Illustrated processing block 1390 provides for determining an address for the next hop in the communication path. For example, the uncompressed adaptation layer header may include a source address and a destination address. The source address may to the previous adaptation layer hop, and the destination address may map to the next adaptation layer hop. When the adaptation layer header is compressed, the compressed adaptation layer header may include an automatic extended route optimization (AERO) forwarding vector index (AFVI) that represents the path from the original source address to the original destination address (e.g., the final destination address). In some embodiments, if the adaptation layer header has previously been compressed, determining the address for the next hop includes decompressing the adaptation layer header, then determining the address for the next adaptation layer hop indicated in the decompressed adaptation layer header, then recompressing the adaptation layer header to regenerate the carrier packet. Alternatively, in some embodiments determining the address for the next hop includes looking up the address using a table having AERO forwarding information base (AFIB) entries, where the AFIB entries are associated with respective compressed adaptation layer headers. In some embodiments, each group of carrier packets includes the same data link layer destination address, which is different from the adaptation layer destination address, which are both different from the original destination address of the original IP packets. That is, each addressing domain is different for different layers in the stack. Then, the method 1300 proceeds to block 1350.

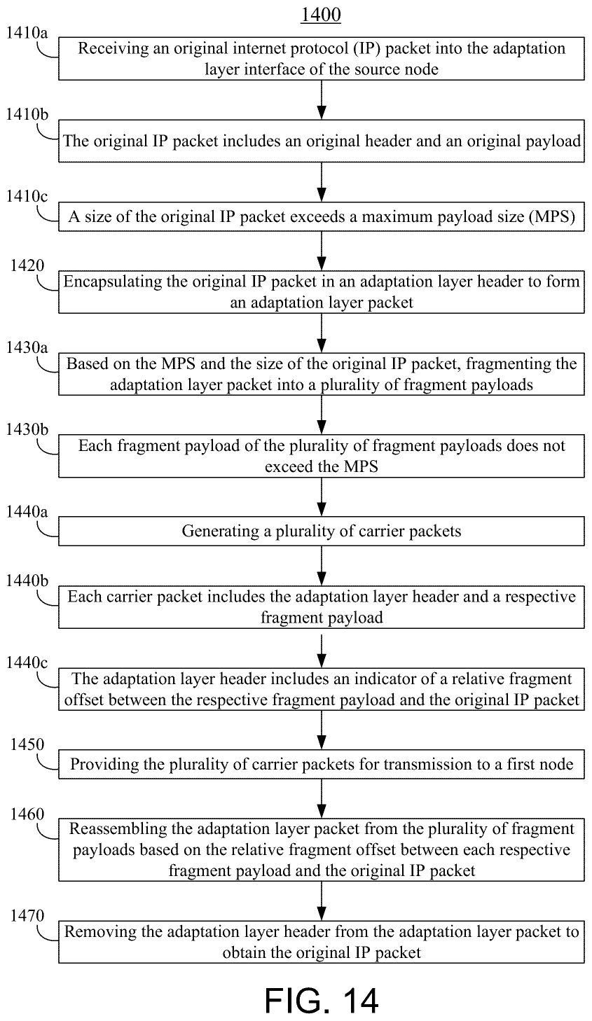

FIG. 14 is a flowchart illustrating a method 1400 of adapting IP for heterogeneous internetworks in accordance with an example. The method 1400 can generally be implemented within the arrangement 100 of FIG. 1. For example, the method 1400 can be implemented to transmit an IP packet between a source node and a destination node in a network communication path having a plurality of nodes, where each node of the plurality of nodes has an adaptation layer interface. More particularly, the method 1400 can be implemented as one or more modules as a set of logic instructions stored in a machine-or computer-readable storage medium such as RAM, ROM, PROM, firmware, flash memory, etc., in hardware, or any combination thereof. For example, hardware implementations can include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

For example, computer program code to carry out the method 1400 can be written in any combination of one or more programming languages, including an object-oriented programming language such as Java, JavaScript, Python, C #, C++, Perl, Smalltalk, or the like and conventional procedural programming languages, such as the “C” programming language or similar programming languages. Additionally, program or logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 1410a provides for receiving an original internet protocol (IP) packet into the adaptation layer interface of the source node, where at block 1410b the original IP packet includes an original header and an original payload, and at block 1410c a size of the original IP packet exceeds a maximum payload size (MPS). Illustrated processing block 1420 provides for encapsulating the original IP packet in an adaptation layer header to form an adaptation layer packet. Illustrated processing block 1430a provides for fragmenting, based on the MPS and the size of the original IP packet, the adaptation layer packet into a plurality of fragment payloads, where at block 1430b each fragment payload of the plurality of fragment payloads does not exceed the MPS. Illustrated processing block 1440a provides for generating a plurality of carrier packets, where at block 1440b each carrier packet includes the adaptation layer header and a respective fragment payload, and at block 1440c the adaptation layer header includes an indicator of a relative fragment offset between the respective fragment payload and the original IP packet. Blocks 1420 through 1440c are performed by the adaptation layer interface of the source node.

At illustrated processing block 1450 the plurality of carrier packets is provided for transmission to a first node of the plurality of nodes in the communication path. In some cases the first the first node is the destination node, while in other cases the first node is an intermediate node.

When the plurality of carrier packets are received at the destination node, illustrated processing block 1460 provides for reassembling the adaptation layer packet from the plurality of fragment payloads based on the relative fragment offset between each respective fragment payload and the original IP packet. Illustrated processing block 1470 provides for removing the adaptation layer header from the adaptation layer packet to obtain the original IP packet. Blocks 1460 through 1470 are performed by the adaptation layer interface of the destination node.

In some examples, the plurality of nodes further includes an intermediate node, and the method 1400 further includes, when one or more of the carrier packets are received at the intermediate node, determining, by the adaptation layer interface of the intermediate node, an address for a second node of the plurality of nodes in the network communication path; and providing the one or more of the carrier packets for transmission to the second node of the plurality of nodes. In some embodiments, the adaptation layer interface of each node comprises an overlay multilink network interface (OMNI) adaptation layer (OAL) interface. In some cases the second node is the destination node, while in other cases the second node is another intermediate node.

In some embodiments, the method 1400 further includes compressing, by the adaptation layer interface of the source node, the adaptation layer header of each carrier packet; and decompressing, by the adaptation layer interface of the destination node, the adaptation layer header of each carrier packet. In some embodiments, determining the address for the second node of the plurality of nodes comprises one of: (A) decompressing the adaptation layer header for one of the one or more of the carrier packets, determining the address based on the decompressed the adaptation layer header, and re-compressing the decompressed the adaptation layer header, or (B) looking up the address using a table having automatic extended route optimization (AERO) forwarding information base (AFIB) entries, where the AFIB entries are associated with respective compressed adaptation layer headers.

In some embodiments, the method 1400 further includes encapsulating, at the source node, each carrier packet with an encapsulation header; and removing, at the destination node, the encapsulation header from each carrier packet. In some embodiments, for each node of the plurality of nodes, the adaptation layer interface is in communication with a network layer and a data link layer, and the encapsulation header is a data link layer header.

The examples disclosed herein are described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples are practiced in a variety of system configurations, including personal computers, laptops, smart phones, mobile tablets, hand-held devices, consumer electronics, specialty computing devices, etc. The disclosed examples are also practiced in distributed computing environments, where tasks are performed by remote-processing devices that are linked through a communications network.

An example method of adapting IP for heterogeneous internetworks comprises: receiving an original IP packet into a source interface, wherein the original IP packet comprises an original header and an original payload, and wherein a size of the original IP packet exceeds a first MPS; based on at least the first MPS and the size of the original IP packet, fragmenting the original IP packet into a plurality of fragment payloads, wherein each fragment payload of the plurality of fragment payloads does not exceed the first MPS; generating a plurality of carrier packets, wherein each carrier packet comprises an encapsulation header and one fragment payload of the plurality of fragment payloads; and transmitting the plurality of carrier packets over a downstream network to a destination interface.

Another example method of adapting IP for heterogeneous internetworks comprises: receiving an original IP packet into a source interface, wherein the original IP packet comprises an original header and an original payload, and wherein a size of the original payload exceeds a first MPS; based on at least the first MPS and the size of the original payload, fragmenting the original IP packet into a plurality of fragment payloads, wherein each fragment payload of the plurality of fragment payloads does not exceed the first MPS; generating a plurality of carrier packets, wherein each carrier packet comprises an encapsulation header and one fragment payload of the plurality of fragment payloads; and transmitting the plurality of carrier packets over a downstream network to a destination interface.

Another example method of adapting IP for heterogeneous internetworks comprises: receiving an original IP packet into a source interface, wherein the original IP packet comprises an original header and an original payload, and wherein a size of the original payload exceeds a first MPS; based on at least the first MPS and the size of the original payload, fragmenting the original payload into a plurality of fragment payloads, wherein each fragment payload of the plurality of fragment payloads does not exceed the first MPS; generating a plurality of carrier packets, wherein each carrier packet comprises an encapsulation header and one fragment payload of the plurality of fragment payloads; and transmitting the plurality of carrier packets over a downstream network to a destination interface.

An example system for adapting IP for heterogeneous internetworks comprises: one or more processors; and a memory storing instructions that, when executed by the one or more processors, cause the one or more processors to perform operations comprising: receiving an original IP packet into a source interface, wherein the original IP packet comprises an original header and an original payload, and wherein a size of the original IP packet exceeds a first MPS; based on at least the first MPS and the size of the original IP packet, fragmenting the original IP packet into a plurality of fragment payloads, wherein each fragment payload of the plurality of fragment payloads does not exceed the first MPS; generating a plurality of carrier packets, wherein each carrier packet comprises an encapsulation header and one fragment payload of the plurality of fragment payloads; and transmitting the plurality of carrier packets over a downstream network to a destination interface.

Another example system for adapting IP for heterogeneous internetworks comprises: one or more processors; and a memory storing instructions that, when executed by the one or more processors, cause the one or more processors to perform operations comprising: receiving an original IP packet into a source interface, wherein the original IP packet comprises an original header and an original payload, and wherein a size of the original payload exceeds a first MPS; based on at least the first MPS and the size of the original payload, fragmenting the original IP packet into a plurality of fragment payloads, wherein each fragment payload of the plurality of fragment payloads does not exceed the first MPS; generating a plurality of carrier packets, wherein each carrier packet comprises an encapsulation header and one fragment payload of the plurality of fragment payloads; and transmitting the plurality of carrier packets over a downstream network to a destination interface.

Another example system for adapting IP for heterogeneous internetworks comprises: one or more processors; and a memory storing instructions that, when executed by the one or more processors, cause the one or more processors to perform operations comprising: receiving an original IP packet into a source interface, wherein the original IP packet comprises an original header and an original payload, and wherein a size of the original payload exceeds a first MPS; based on at least the first MPS and the size of the original payload, fragmenting the original payload into a plurality of fragment payloads, wherein each fragment payload of the plurality of fragment payloads does not exceed the first MPS; generating a plurality of carrier packets, wherein each carrier packet comprises an encapsulation header and one fragment payload of the plurality of fragment payloads; and transmitting the plurality of carrier packets over a downstream network to a destination interface.

An example computer program product comprises a computer usable medium having a computer readable program code embodied therein, the computer readable program code adapted to be executed to implement a method comprising: receiving an original IP packet into a source interface, wherein the original IP packet comprises an original header and an original payload, and wherein a size of the original IP packet exceeds a first MPS; based on at least the first MPS and the size of the original IP packet, fragmenting the original IP packet into a plurality of fragment payloads, wherein each fragment payload of the plurality of fragment payloads does not exceed the first MPS; generating a plurality of carrier packets, wherein each carrier packet comprises an encapsulation header, an adaptation layer header, and one fragment payload of the plurality of fragment payloads; and transmitting the plurality of carrier packets over a downstream network to a destination interface.

Another example computer program product comprises a computer usable medium having a computer readable program code embodied therein, the computer readable program code adapted to be executed to implement a method comprising: receiving an original IP packet into a source interface, wherein the original IP packet comprises an original header and an original payload, and wherein a size of the original payload exceeds a first MPS; based on at least the first MPS and the size of the original payload, fragmenting the original IP packet into a plurality of fragment payloads, wherein each fragment payload of the plurality of fragment payloads does not exceed the first MPS; generating a plurality of carrier packets, wherein each carrier packet comprises an encapsulation header, an adaptation layer header, and one fragment payload of the plurality of fragment payloads; and transmitting the plurality of carrier packets over a downstream network to a destination interface.

Another example computer program product comprises a computer usable medium having a computer readable program code embodied therein, the computer readable program code adapted to be executed to implement a method comprising: receiving an original IP packet into a source interface, wherein the original IP packet comprises an original header and an original payload, and wherein a size of the original payload exceeds a first MPS; based on at least the first MPS and the size of the original payload, fragmenting the original payload into a plurality of fragment payloads, wherein each fragment payload of the plurality of fragment payloads does not exceed the first MPS; generating a plurality of carrier packets, wherein each carrier packet comprises an encapsulation header, an adaptation layer header, and one fragment payload of the plurality of fragment payloads; and transmitting the plurality of carrier packets over a downstream network to a destination interface.

Alternatively, or in addition to the other examples described herein, examples include any combination of the following:
the source interface comprises an OAL interface and the destination interface comprises an OAL interface;
probing, by the source interface, to determine a largest MPS supported by the downstream network;
probing comprises iteratively transmitting a trial packet over the downstream network;
the trial packet comprises a trial payload;
a size of the trial payload matches a trial MPS;
probing comprises iteratively increasing the trial MPS until receiving an indication that a trial packet is too large;
the largest MPS supported is determined to be a largest trial MPS for which the indication that a trial carrier packet is too large is not received;
receiving, by the source interface, IP packets from a plurality of downstream-dependent devices that are connected to the source interface;
based on at least the first MPS and sizes of payloads of the IP packets from the plurality of downstream-dependent devices, fragmenting the IP packets from the plurality of downstream-dependent devices into sets of carrier packets;
transmitting the sets of carrier packets;
each carrier packet further comprises an adaptation layer header;
receiving, by the destination interface, the plurality of carrier packets;
reassembling the original IP packet from the plurality of fragment payloads;
calculating a checksum;
calculation of the checksum includes at least the original payload;
calculation of the checksum includes at least the original header;
calculation of the checksum includes at least the original IP packet;
including the checksum within a carrier packet of the plurality of carrier packets;
the destination interface comprises an intermediate interface;
based on at least a second MPS and the size of the original IP packet, fragmenting the original IP packet into a second plurality of fragment payloads;
each fragment payload of the second plurality of fragment payloads does not exceed the second MPS;
generating a second plurality of carrier packets, wherein each carrier packet comprises an encapsulation header and one fragment payload of the second plurality of fragment payloads;
transmitting, by the intermediate interface, the second plurality of carrier packets over a second downstream network to a second destination interface;
the encapsulation header comprises a payload length field;
the encapsulation header comprises a 16-bit payload length field;
a larger MPS reduces a count of fragments required for reassembling an IP packet;
receiving the trial packet into the source interface from a downstream-dependent device;
the trial packet comprises an IP packet received from a downstream-dependent device;
performing the probing with an IP packet received from a downstream-dependent device;
generating, by the source interface, the trial packet;
the trial packet comprises an IP packet generated for the purpose of probing;
performing the probing with an IP packet generated for the purpose of probing;
the indication that a trial packet is too large comprises a received error message;
the error message comprises a PTB message;
the indication that a trial packet is too large comprises failing to receive an acknowledgement that the trial packet was received;
copying information from the original header into the adaptation layer header;
copying “Type of Service/Traffic Class” and/or “Congestion Experienced” values from the original header into the adaptation layer header;
the adaptation layer header is located between the encapsulation header and the fragment payload within each carrier packet;
the adaptation layer header comprises an IPv6 header;
the calculation of the checksum further includes the adaptation layer header;
the calculation of the checksum is performed on a concatenation of the adaptation layer header and the original payload;
including the checksum within a final carrier packet of the plurality of carrier packets;
after reassembling the original IP packet, determining whether a newly calculated checksum matches the checksum included in the carrier packet;
based on at least determining that the newly calculated checksum matches the checksum included in the carrier packet, continuing delivery of the original payload; and
based on at least determining that the newly calculated checksum does not match the checksum included in the carrier packet, discarding the original payload.

When introducing elements of aspects of the disclosure or the implementations thereof, the articles “a,” “an,” “the,” and “said” are intended to mean that there are one or more of the elements. The terms “comprising,” “including,” and “having” are intended to be inclusive and mean that there could be additional elements other than the listed elements. The term “implementation” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. In a network communication path having a plurality of nodes including a source node and a destination node, each node of the plurality of nodes having an adaptation layer interface, a method comprising:
receiving an original internet protocol (IP) packet into the adaptation layer interface of the source node, wherein the original IP packet comprises an original header and an original payload, and wherein a size of the original IP packet exceeds a maximum payload size (MPS);
performing, by the adaptation layer interface of the source node, operations comprising:
encapsulating the original IP packet in an adaptation layer header to form an adaptation layer packet;
based on at least the MPS and the size of the original IP packet, fragmenting the adaptation layer packet into a plurality of fragment payloads, wherein each fragment payload of the plurality of fragment payloads does not exceed the MPS; and
generating a plurality of carrier packets, wherein each carrier packet comprises a respective adaptation layer header and a respective fragment payload of the plurality of fragment payloads, and wherein for each carrier packet the respective adaptation layer header includes an indicator of a relative fragment offset associated with the respective fragment payload;
providing the plurality of carrier packets for transmission to a first node of the plurality of nodes; and
when the plurality of carrier packets are received at the destination node, performing, by the adaptation layer interface of the destination node, operations comprising:
reassembling the adaptation layer packet from the plurality of fragment payloads based on the relative fragment offset associated with each respective fragment payload; and
removing the adaptation layer header from the adaptation layer packet to obtain the original IP packet.

2. The method of claim 1, wherein the plurality of nodes further includes an intermediate node, and wherein the method further comprises:
when one or more of the carrier packets are received at the intermediate node, determining, by the adaptation layer interface of the intermediate node, an address for a second node of the plurality of nodes; and
providing the one or more of the carrier packets for transmission to the second node of the plurality of nodes.

3. The method of claim 2, wherein determining the address for the second node of the plurality of nodes comprises one of:
decompressing an adaptation layer header of at least one of the one or more of the carrier packets, determining the address based on the decompressed adaptation layer header, and re-compressing the decompressed the adaptation layer header; or
looking up the address using a table having automatic extended route optimization (AERO) forwarding information base (AFIB) entries, wherein the AFIB entries are associated with respective compressed adaptation layer headers.

4. The method of claim 1, wherein the adaptation layer interface of each node comprises an overlay multilink network interface (OMNI) adaptation layer (OAL) interface.

5. The method of claim 1, further comprising:
compressing, by the adaptation layer interface of the source node, each respective adaptation layer header of each carrier packet; and
decompressing, by the adaptation layer interface of the destination node, each respective adaptation layer header of each carrier packet.

6. The method of claim 1, further comprising:
encapsulating, at the source node, each carrier packet with an encapsulation header; and
removing, at the destination node, the encapsulation header from each carrier packet.

7. The method of claim 6, wherein for each node of the plurality of nodes, the adaptation layer interface is in communication with a network layer and a data link layer, and wherein the encapsulation header comprises a data link layer header.

8. A computer program product, comprising a non-transitory computer usable medium having a computer readable program code embodied therein, the computer readable program code adapted to be executed to implement a method in a network communication path having a plurality of nodes including a source node and a destination node, each node of the plurality of nodes having an adaptation layer interface, the method comprising:
receiving an original internet protocol (IP) packet into the adaptation layer interface of the source node, wherein the original IP packet comprises an original header and an original payload, and wherein a size of the original IP packet exceeds a maximum payload size (MPS);
performing, by the adaptation layer interface of the source node, operations comprising:
encapsulating the original IP packet in an adaptation layer header to form an adaptation layer packet;
based on at least the MPS and the size of the original IP packet, fragmenting the adaptation layer packet into a plurality of fragment payloads, wherein each fragment payload of the plurality of fragment payloads does not exceed the MPS; and
generating a plurality of carrier packets, wherein each carrier packet comprises a respective adaptation layer header and a respective fragment payload of the plurality of fragment payloads, and wherein for each carrier packet the respective adaptation layer header includes an indicator of a relative fragment offset for the respective fragment payload;
providing the plurality of carrier packets for transmission to a first node of the plurality of nodes; and
when the plurality of carrier packets are received at the destination node, performing, by the adaptation layer interface of the destination node, operations comprising:
reassembling the adaptation layer packet from the plurality of fragment payloads based on the relative fragment offset for each respective fragment payload; and
removing the adaptation layer header from the adaptation layer packet to obtain the original IP packet.

9. The computer program product of claim 8, wherein the plurality of nodes further includes an intermediate node, and wherein the method further comprises:
when one or more of the carrier packets are received at the intermediate node, determining, by the adaptation layer interface of the intermediate node, an address for a second node of the plurality of nodes; and
providing the one or more of the carrier packets for transmission to the second node of the plurality of nodes.

10. The computer program product of claim 9, wherein determining the address for the second node of the plurality of nodes comprises one of:
decompressing an adaptation layer header of at least one of the one or more of the carrier packets, determining the address based on the decompressed adaptation layer header, and re-compressing the decompressed the adaptation layer header; or
looking up the address using a table having automatic extended route optimization (AERO) forwarding information base (AFIB) entries, wherein the AFIB entries are associated with respective compressed adaptation layer headers.

11. The computer program product of claim 8, wherein the adaptation layer interface of each node comprises an overlay multilink network interface (OMNI) adaptation layer (OAL) interface.

12. The computer program product of claim 8, further comprising:
compressing, by the adaptation layer interface of the source node, the respective adaptation layer header of each carrier packet; and
decompressing, by the adaptation layer interface of the destination node, the respective adaptation layer header of each carrier packet.

13. The computer program product of claim 8, further comprising:
encapsulating, at the source node, each carrier packet with an encapsulation header; and
removing, at the destination node, the encapsulation header from each carrier packet.

14. The computer program product of claim 13, wherein for each node of the plurality of nodes, the adaptation layer interface is in communication with a network layer and a data link layer, and wherein the encapsulation header comprises a data link layer header.

15. A system comprising a plurality of nodes including a source node and a destination node, each node of the plurality of nodes having an adaptation layer interface;
wherein the source node includes a first processor and a first memory storing first instructions that, when executed by the first processor, cause the first processor to perform operations comprising:
receiving an original internet protocol (IP) packet into the adaptation layer interface of the source node, wherein the original IP packet comprises an original header and an original payload, and wherein a size of the original IP packet exceeds a maximum payload size (MPS);
encapsulating the original IP packet in an adaptation layer header to form an adaptation layer packet;
based on at least the MPS and the size of the original IP packet, fragmenting the adaptation layer packet into a plurality of fragment payloads, wherein each fragment payload of the plurality of fragment payloads does not exceed the MPS;
generating a plurality of carrier packets, wherein each carrier packet comprises a respective adaptation layer header and a respective fragment payload of the plurality of fragment payloads, and wherein for each carrier packet the adaptation layer header includes an indicator of a relative fragment offset of the respective fragment payload; and
providing the plurality of carrier packets for transmission to a first node of the plurality of nodes; and
wherein the destination node includes a second processor and a second memory storing second instructions that, when executed by the second processor, cause the second processor to perform operations comprising:
receiving the plurality of carrier packets into the adaptation layer interface of the destination node,
reassembling the adaptation layer packet from the plurality of fragment payloads based on the relative fragment offset for each respective fragment payload; and
removing the adaptation layer header from the adaptation layer packet to obtain the original IP packet.

16. The system of claim 15, wherein the plurality of nodes further includes an intermediate node including a third processor and a third memory storing third instructions that, when executed by the third processor, cause the third processor to perform operations comprising:
receiving one or more of the carrier packets into the adaptation layer interface of the intermediate node;
determining an address for a second node of the plurality of nodes; and
providing the one or more of the carrier packets for transmission to the second node of the plurality of nodes.

17. The system of claim 16, wherein determining the address for the second node of the plurality of nodes comprises one of:
decompressing an adaptation layer header of at least one of the one or more of the carrier packets, determining the address based on the decompressed adaptation layer header, and re-compressing the decompressed the adaptation layer header; or
looking up the address using a table having automatic extended route optimization (AERO) forwarding information base (AFIB) entries, wherein the AFIB entries are associated with respective compressed adaptation layer headers.

18. The system of claim 15, wherein the adaptation layer interface of each node comprises an overlay multilink network interface (OMNI) adaptation layer (OAL) interface.

19. The system of claim 15, wherein:
the first instructions, when executed by the first processor, cause the first processor to perform further operations comprising compressing the respective adaptation layer header of each carrier packet; and
the second instructions, when executed by the second processor, cause the second processor to perform further operations comprising decompressing the respective adaptation layer header of each carrier packet.

20. The system of claim 15, wherein:
the first instructions, when executed by the first processor, cause the first processor to perform further operations comprising encapsulating each carrier packet with an encapsulation header; and
the second instructions, when executed by the second processor, cause the second processor to perform further operations comprising removing the encapsulation header from each carrier packet.
